(19) United States
(12) Patent Application Publication
(10) Pub. No.: US 2016/0350317 A1
(43) Pub. Date: Dec. 1, 2016

(54) METHOD FOR CONVERTING AT LEAST ONE SAFETY CONFIGURATION FILE

(71) Applicant: KUKA Roboter GmbH, Augsburg (DE)

(72) Inventors: Robert Bertossi, Friedberg (DE); Giulio Milighetti, Augsburg (DE); Christian Hartmann, Konigsbrunn (DE); Thomas Fuerst, Augsburg (DE); Marc Ueberle, Friedberg (DE); Alexander Melkozerov, Friedberg (DE); Uwe Bonin, Augsburg (DE)

(21) Appl. No.: 15/164,153

(22) Filed: May 25, 2016

(30) Foreign Application Priority Data
May 29, 2015 (DE) 10 2015 209 895.8

(51) Int. Cl. G06F 17/30

(52) U.S. Cl. CPC G06F 17/30076; G06F 17/30371

(57) ABSTRACT

A method and a data processing system for converting at least one first safety configuration file of a control device into a second safety configuration file by means of a converter. Thereafter, the consistency of the first safety configuration file and the second safety configuration file is checked by means of a consistency checking unit. An identifier of the second safety configuration file is initially set to correspond with an identifier of the first safety configuration file, and is changed if an inconsistency is found during the consistency check. If the identifier of the second safety configuration file has been changed and no longer corresponds to the identifier of the first safety configuration file, the control device prevents activation of the second safety configuration file and manipulator.

This application claims the benefit of priority under 35 §119(a) to German Patent Application No. 10 2015 209 895.8, filed on May 29, 2015.

### 1. AREA OF THE INVENTION

The invention relates to a method for converting at least one safety configuration file into a second safety configuration file and a data processing system, which is configured to execute the method, and a machine-readable medium, which contains instructions which cause a data processing system to execute the method.

### 2. BACKGROUND

Safety configuration files typically determine a safety configuration of a safety control device. Safety control devices are typically used in safety-relevant machines and/or processes, i.e., in machines and/or processes which can represent a hazard to humans and/or the environment. In this case, the safety control device monitors the process and/or the machine and engages if limits are exceeded, which are defined by the safety configuration. For example, the process and/or the machine is stopped by the engagement of the safety control device.

For example, safety control devices are used in manipulator systems in the industrial environment. A manipulator system comprises at least one manipulator, a control device, which controls movements of the manipulator, and a safety control device, which monitors the control device and the manipulator. A manipulator can be an industrial robot, for example. Industrial robots are typically automatically guided multipurpose manipulators, which are equipped with three or more freely programmable movement axes, and which are used in either a stationary or mobile manner in industrial applications.

A safety control device of a manipulator typically provides multiple safety functions, for example, monitoring the maintenance of defined axis ranges of the movement axes, the forces and/or torques acting on the manipulator, maintaining permissible speeds and/or accelerations, maintaining a spatial workspace and possible collisions with further manipulators or humans and/or objects located in the surroundings. Further safety functions or a combination of safety functions are also possible.

A safety configuration file determines which specific safety functions are to be monitored by the safety control device (safety configuration) and specifies by means of safety parameters which limits are to be maintained. Safety parameters can be, for example, rotational angle ranges, which are specified on an axis, for example, 10° to 45°, or maximum permissible torque values, which are permissible on an axis, for example, at most 50 Nm.

In the event of a change to the safety control device, for example, an update of the safety control software, the format of the safety configuration also frequently changes, for example, because new safety functions are provided or existing safety functions require additional or different safety parameters. The unit of the safety parameters can also change, for example. Thus, in the mentioned example of the monitoring of axis ranges, a change of the unit of the rotational angle from degrees to thousandths of a degree is conceivable.

If the changed safety control device no longer supports the old format of the safety configuration, the at least one safety configuration file has to be converted. This conversion of the safety configuration file is also necessary when the previous safety functions and safety parameters are to be taken over unchanged after the change of the safety control device.

This conversion is typically performed by means of manual editing of the safety configuration file by a programmer.

To be able to uniquely identify the safety configuration file, it typically has an identifier, which is formed from the checksum of the binary file. However, since the converted, second safety configuration file is no longer identical to the previous, first safety configuration file, a different checksum of the binary file results, i.e., a different identifier.

The safety control device recognizes the change of the safety configuration file on the basis of the change of the identifier and requests verification and activation of the second safety configuration file by, for example, an authorized safety startup engineer, whereby a substantial effort arises. During the verification, the safety startup engineer typically has to check on the basis of physical tests whether the converted safety configuration file was correctly taken over by the safety control device and achieves the expected effect. The verification additionally has to be documented for evidentiary purposes.

It is therefore the object of the present invention to reduce the conversion and verification effort upon the conversion of a first safety configuration file and to remedy further described disadvantages. This object is achieved by a method according to claim 1, a data processing system according to claim 13, and a machine-readable medium according to claim 14.

### 3. DETAILED DESCRIPTION OF THE INVENTION

In particular, the object is achieved by a method for converting at least one first safety configuration file of a safety control device into a second safety configuration file, wherein the safety control device is preferably a manipulator safety control device, and wherein the method comprises the following method steps:

a) converting the first safety configuration file into a second safety configuration file by means of a converter, and b) checking the consistency of the first safety configuration file and the second safety configuration file by means of a consistency checking unit.

The safety configuration file is preferably configured for the purpose of monitoring another system, for example, a manipulator and/or a control device. The safety control device can preferably engage in the system to be monitored and, for example, force a stop of the system. The safety control device can also be configured to monitor a model of the other system.

Due to the conversion of the first safety configuration file into a second safety configuration file by means of a converter, manual editing by a programmer is no longer necessary. The checking of the consistency of the first safety configuration file and the second safety configuration file by means of a consistency checking unit additionally enables, if a consistency is determined of the checked safety configuration files, the tests required for verification of the second safety configuration file to be omitted.

The first safety configuration file preferably has at least one first identifier and first configuration data and the conversion of the first safety configuration file comprises at least the conversion of the configuration data, wherein the configuration data comprise safety parameters and/or safety function selection parameters. Safety function selection parameters specify, for example, what is to be monitored, for example, the rotational angle of the axis 1, or the torque of a manipulator (for example, of a multi-axis articulated arm robot) applied to the axis 2. The safety parameters designate and/or define the associated limiting values. For example, the rotational angle of axis 1 is to be in a specific range from 10° to 40°, and the torque applied to axis 2 is not to exceed a specific value, for example, 50 Nm. A change of the safety configuration can comprise changes to both the safety function selection parameters and also the associated safety parameters. It is conceivable, for example, that in the event of a change, the monitoring of the rotational angle of axis 1 is no longer necessary, so that this safety function selection parameter is no longer required.

The provision of an identifier, which is assigned to the safety configuration file, is advantageous, since the activation of an unsuitable safety configuration file can thus be avoided. This prevents the operation of the system using an unsuitable safety configuration. For example, in a manipulator system, which comprises a manipulator, a control device, and a safety control device, the identifier of the presently valid safety configuration file, i.e., the activated safety configuration file, is stored. Before the manipulator system can be put into operation, it is checked whether the stored identifier corresponds to the identifier of the safety configuration file stored in the system. If the identifiers correspond, the manipulator system can thus be started and the manipulator can be moved.

Otherwise, an activation of the safety configuration file, which is stored in the system, by an operator is necessary. If the operator approves the activation, the identifier of the safety configuration file activated by the operator is thus saved in the system and the system is put into operation using the now activated safety configuration file. If the operator does not approve the activation, the safety configuration file is thus unsuitable and the system cannot be put into operation, whereby a movement of the manipulator is preferably suppressed.

An allocation of the configuration data into safety parameters and safety function selection parameters is advantageous, since the conversion can be performed in two steps. For example, if safety functions are no longer present in a changed safety control device, the associated safety parameters thus do not have to be converted, whereby the conversion can be accelerated.

The identifier of the first safety configuration file is preferably not converted, so that the second safety configuration file has the same identifier as the first safety configuration file.

The use of the same identifier for the first safety configuration file and the converted second safety configuration file is advantageous, since the second safety configuration file does not have to be activated by an operator. This is true because the identifier of the presently valid safety configuration file (the first safety configuration file) is saved in the monitored system. Since the second safety configuration file has the same identifier, the second safety configuration file can be used without prior activation and verification.

The identifier of the first safety configuration file is preferably an independent identifier. An independent identifier is an identifier which does not originate directly from the safety configuration file itself. A dependent identifier would be, for example, the checksum of the binary file of the safety configuration file. The use of an independent identifier is advantageous, since the identifier which is used for the first safety configuration file can thus be transferred, without converting it, directly to the second safety configuration file. This enables, as described above, a use of the second safety configuration file without prior activation and verification.

It is preferably checked during the checking of the consistency of the first and second safety configuration files whether the safety function selection parameters, which are implemented in the first safety configuration file, are also implemented in the second safety configuration file.

The check as to whether the same safety function selection parameters are implemented both in the first and also in the second safety configuration file enables a rapid determination of possible inconsistencies. For example, if safety functions are no longer available in a changed version of the safety control device, this can already be determined before checking the consistency of the safety parameters.

Upon the checking of the consistency of the first and second safety configuration files, it is particularly preferably checked whether the safety parameters which are implemented in the first safety configuration file correspond to the safety parameters which are implemented in the second safety configuration file.

If the safety parameters of the first safety configuration file and the second safety configuration file correspond, the safety configuration files, in combination with the safety control device associated therewith, thus unfold the same effect. If the safety parameters define maximum permissible rotational angles, for example, the rotational angles defined by the safety parameters thus also have to correspond in the physical significance thereof. It can be determined by the checking of the safety parameters whether they have been correctly converted.

If safety parameters and safety function selection parameters are checked for consistency separately from one another, errors which have arisen during the conversion can be rapidly recognized and assigned to the corresponding parameter. If inconsistencies arise, this enables efficient later manual editing of the second safety configuration file.

Preferably, the identifier of the second safety configuration file is changed and/or an error message is output if an inconsistency is determined when checking the consistency. The change of the identifier of the second safety configuration file prevents the use of the second safety configuration file without prior verification and activation by an operator, if inconsistencies have arisen, since the identifier does not correspond to the identifier stored in the system. The output of an error message is advantageous, since an operator immediately recognizes an inconsistent conversion. In the case of an inconsistent conversion, the first safety configuration file is preferably maintained, i.e., the second safety configuration file is not activated. Inconsistencies can arise, for example, as a result of programming errors in the converter or as a result of data transmission errors. It can preferably be determined on the basis of rule sets whether an inconsistency actually exists. The rule sets define permitted deviations in the safety parameters. For example, if the accuracy of a safety parameter is changed in new safety control software of the safety controller, such deviations can arise, which do not necessarily result in an inconsistency. Therefore, the first and second safety configuration file or the safety parameters thereof and/or the safety function selection parameters thereof do not necessarily have to completely correspond to achieve a consistency.

The method preferably furthermore comprises the following method step:

c) preparing a first delta list by means of the converter if a complete conversion of the first safety configuration file into a second safety configuration file is not possible, wherein the first delta list indicates deviations of the first safety configuration file from the second safety configuration file.

The deviations of the first safety configuration file from the second safety configuration file can comprise deviations in both safety parameters and also in safety function selection parameters. The first delta list preferably indicates whether safety functions which are selected by the safety function selection parameters are available in the changed safety control device, and therefore whether the safety configuration files are completely convertible at all. The first delta list therefore indicates inconsistencies which originate from incompatible changes of the safety control device. To remain with the above example relating to the rotational angle monitoring of axis 1 of a manipulator and the torque of axis 2, for example, the monitoring of the rotational angle of axis 1 should no longer be necessary, for example, so that this safety function selection parameter is no longer required. In this case, the converter also cannot convert this safety function selection parameter and the associated safety parameters.

Furthermore, the lack of availability of a safety function selection parameter after a change of the safety control device can be a result of an update of the safety control software (upgrade) or the renewed use of an older version of the safety control software (downgrade). Furthermore, the lack of availability can be a result of an omission by a user of option packets of the safety control software (cost savings) or the replacement of a safety function by an incompatible new safety function.

For example, Cartesian speed monitoring of the tool center point (TCP) of a manipulator is replaced by Cartesian speed monitoring, this speed monitoring, in addition to the TCP speed, additionally monitoring the speed of the entire manipulator. If the converter now automatically replaces the old, first safety configuration file comprising the speed monitoring of TCP with the new speed monitoring of TCP and manipulator, further safety parameters have to be provided for the speed monitoring of the manipulator. In this example, the delta list would inform a startup engineer about this inconsistency. Subsequently, the startup engineer could check the new, additional speed monitoring of the entire manipulator.

The preparation of the delta list by means of the converter is advantageous since in this way it can already be established during the conversion whether inconsistencies arise as a result of incompatible changes. An operator can thus recognize rapidly and easily in the described exemplary case that the inconsistency is not problematic, since the inconsistency is not based on an error, but rather is a result of an intentional change of the safety functions. If this is the only inconsistency, the operator can release the second safety configuration file.

The first delta list is preferably output to an operator. The output of the delta list is preferably performed on a graphic user interface (GUI). Other forms of output, for example, printing out the delta list, are also possible. The output of the delta list enables the operator to later manually edit the second safety configuration file efficiently. For example, safety functions which are no longer available or are available in altered form in the changed safety control unit can be manually replaced by an equivalent selection of safety functions or a combination of safety functions.

The part of the safety configuration file which is not acquired by the delta list of the converter can be transmitted to the consistency checking unit for checking the (partial) consistency. Therefore, at least parts of the safety configuration file can be activated without a prior verification.

The method preferably comprises at least the following further method steps:

d) preparing a second delta list by means of the consistency checking unit, wherein the second delta list specifies deviations of the first safety configuration file from the second safety configuration file, and

e) outputting the delta lists.

The preparation of a second delta list by means of the consistency checking unit is advantageous, since inconsistencies which are caused by the converter (and not by an intentional change) can also be determined. If the delta lists prepared by the converter and the consistency checking unit do not correspond, in addition to an inconsistency as a result of incompatible changes (as described above, for example, due to the omission of the rotational angle monitoring), a further inconsistency has arisen. To remain in the above example, this can be because the safety parameters of the torque of axis 2 were converted incorrectly, and a maximum permissible torque of 500 Nm has incorrectly been entered in the second safety configuration file. In this case, the second safety configuration file has to be manually verified by the operator. If the delta lists are output, an operator can thus check whether a possible inconsistency is a result of incorrect conversion or is a result of the output or the representation of the delta lists. If the delta lists prepared by the converter and the consistency checking unit correspond, the converted part of the safety configuration file is thus also consistent. This part can therefore be activated without prior verification.

The method preferably comprises at least the following further method step:

f) activation of the second safety configuration file if the identifier of the second safety configuration file corresponds to an identifier which is stored in a safety control device.

The activation of the second safety configuration file is preferably performed in that the second safety configuration file is already activated as the “default” value and is deactivated if the identifier of the second safety configuration file does not correspond to the identifier which is stored in a safety control device. The condition that the identifier of the second safety configuration file has to correspond to an identifier which is stored in a safety control device in order to activate the second safety configuration file prevents inconsistently converted safety configuration files from being activated. As already described, the second safety configuration file can preferably be activated automatically, i.e., without activation and verification by an operator, if it has the same identifier as the first safety configuration file.

The conversion and/or the checking of the consistency can preferably be performed “off-line.” The term “off-line” in this context means that the conversion and/or checking of the consistency of the safety configuration files can also be performed without a connection to a control device of a manipulator or to a safety control device. The conversion and checking of the consistency can preferably be executed in a separate data processing system. The conversion and checking of the consistency is therefore spatially and chronologically separated from the activation and/or the checking of the activation in the safety control device and can be executed independently.

The method preferably furthermore comprises the following steps:

g) editing a first safety configuration file into a second safety configuration file by means of an editor;

h) preparing a third delta list by means of the editor, wherein the third delta list indicates deviations of the first safety configuration file from the second safety configuration file;

i) checking the consistency of the first safety configuration file and the second safety configuration file by means of a consistency checking unit;

j) outputting the second and third delta lists.

The manual editing of the first safety configuration file into a second safety configuration file and the subsequent preparation of a third delta list enable manual engagement in the safety configuration file, without generating a high level of verification effort. If the deviations, which are ascertained by the consistency checking unit, of the first safety configuration file from the second safety configuration file (second delta list) correspond to the third delta list, only the deviations of the second and third delta lists thus have to be manually verified. The part of the second safety configuration file which is not subjected to changes can be activated without prior verification.

The objects are furthermore achieved by a data processing system which is configured for carrying out the above-described method.

A data processing system is preferably a computer system, which can carry out the conversion and checking of the consistency when the converter and the consistency checking unit are available. The data processing system is particularly preferably an operating device of a manipulator control device or also be the manipulator control device itself. The method can therefore be executed on components provided in the manipulator system. In this case, the converter and the consistency checking unit are preferably configured on the data processing system. The converter and the consistency checking unit are particularly preferably two software modules which are independent of one another.

The objects are furthermore achieved by a machine-readable medium which contains instructions, which cause the data processing system to execute the described method. The machine-readable medium is preferably a portable machine-readable medium, for example, a CD, a USB stick, or other portable storage units. This is advantageous since instructions for executing the method can thus be executed easily on different data processing systems.

### 4. DESCRIPTION OF PREFERRED EMBODIMENTS

The invention will be explained in greater detail hereafter with reference to the appended figures. In the figures:

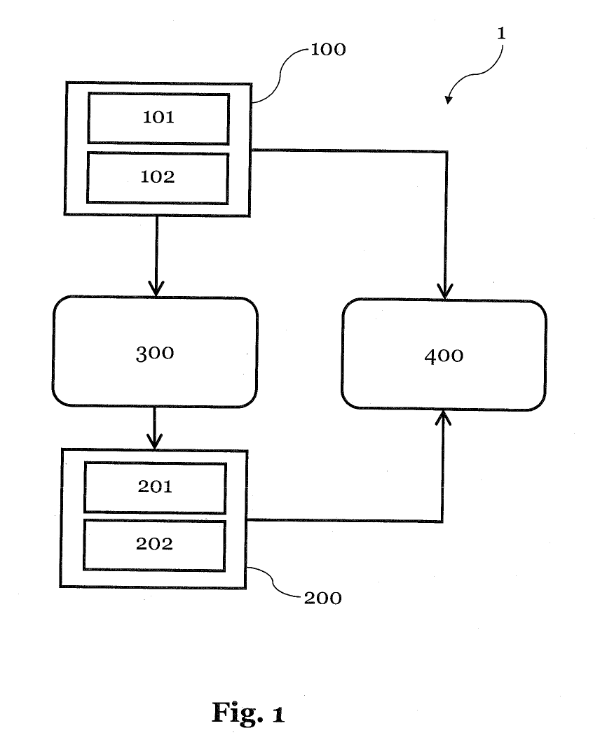

FIG. 1 shows a method for converting a first safety configuration file;

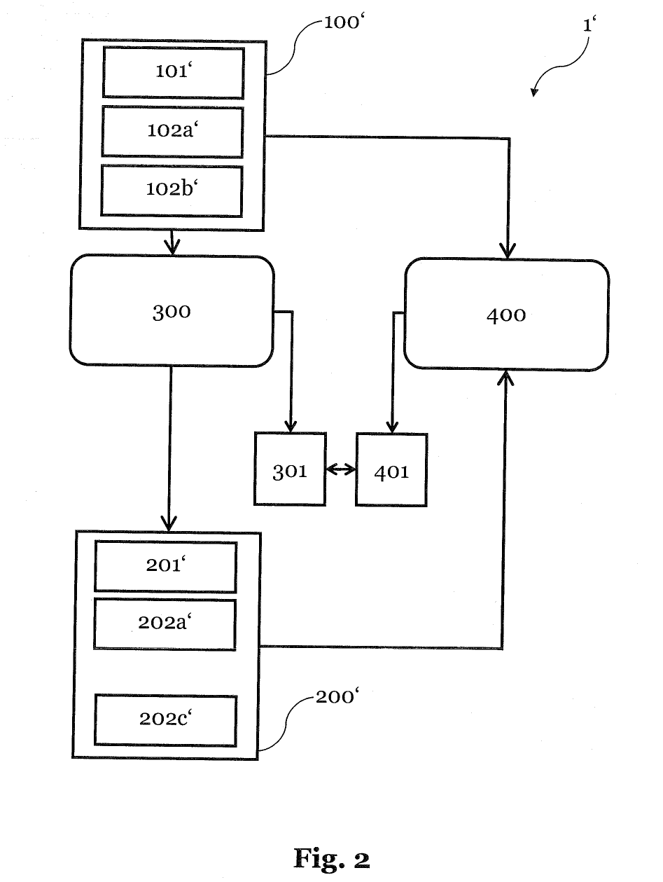

FIG. 2 shows an expanded method for converting a first safety configuration file; and

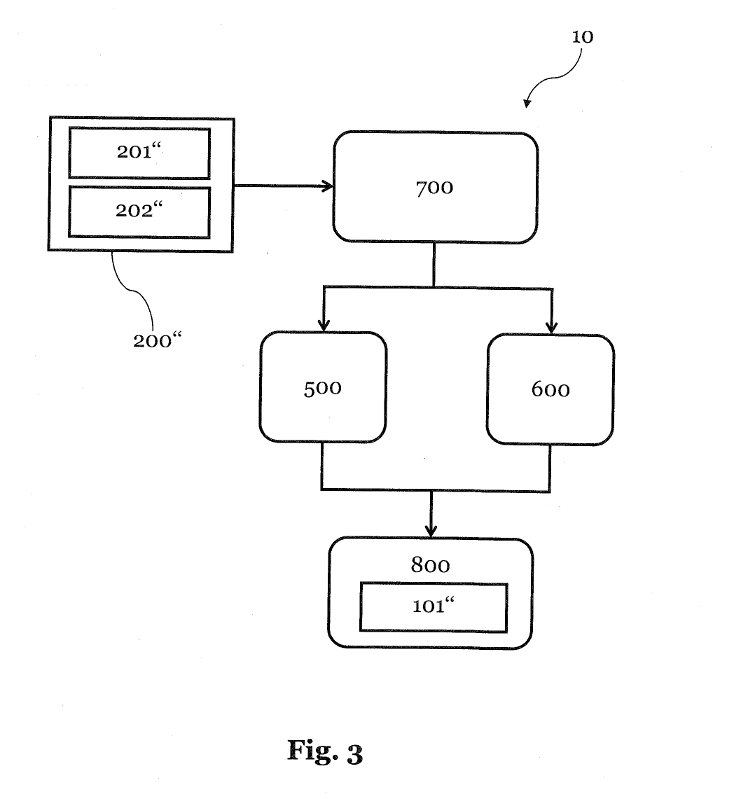

FIG. 3 shows a method for activating a second safety configuration file.

FIG. 1 schematically shows a preferred method 1 for converting a first safety configuration file 100 by means of a converter 300 into a second safety configuration file 200. The first safety configuration file 100 comprises an identifier 101 and configuration data 102, which preferably comprise safety parameters and safety function selection parameters.

The conversion of the first safety configuration file 100 becomes necessary, for example, as a result of a change of the safety control device assigned to the safety configuration file. For example, the safety control software can change, and units, variable names, or the accuracy with which the safety parameters are detected can thus change A conversion of the safety configuration file 100 is therefore necessary.

Furthermore, a change of the safety control device can comprise the provision of new safety functions or the provision of additional safety parameters for existing safety functions. Typical examples of additional safety parameters are, for example, the change of a Cartesian workspace monitoring of all axes of a manipulator and a tool within a configured workspace, into a separate monitoring of the axes of the manipulator and/or the tool. In the case of a consistent conversion, the safety parameters would therefore have to be provided separately for the manipulator and the tool. If the change were reversed again, and, for example, only the tool were monitored, a consistent conversion would thus not be possible.

The converted, second safety configuration file 200 comprises an identifier 201 and converted configuration data 202. The identifier 101 of the first safety configuration file 100 is preferably identical to the identifier 201 of the second safety configuration file 200. The identifier 201 is preferably only to deviate from the identifier 101 if the first safety configuration file 100 was not converted consistently into the second safety configuration file 200.

It is ascertained by means of the consistency checking unit 400 whether the first safety configuration file 100 and the second safety configuration file 200 were converted consistently. If the consistency of the two safety configuration files 100, 200 is determined in this case, the second safety configuration file 200 can be activated without prior verification by an operator and the system can be put into operation. An exemplary activation of a safety configuration file is shown in FIG. 3.

FIG. 2 schematically shows a preferred expanded method 1′ for converting a first safety configuration file 100′ into a second safety configuration file 200′ by means of the converter 300 from FIG. 1. The first safety configuration file 100′ comprises an identifier 101′ and configuration data 102a′, 102b′. The second safety configuration file 200′ comprises an identifier 201′ and configuration data 202a′, 202c′. The configuration data 102a′ are, for example, assigned to a first safety function, for example, the torque monitoring of the axis 2 of a manipulator. This configuration data 102a′ can be converted by means of the converter 300 into corresponding configuration data 202a′ of the second safety configuration file 200′.

The configuration data 102b′ are assigned, for example, to a further safety function, for example, the rotational angle monitoring of the axis 1 of the manipulator. This safety function should no longer be available in this example in the changed safety control device (i.e., it is no longer available). Therefore, the configuration data 102b′ cannot be converted. An incompatible change of the safety control device is present, which can optionally be remedied by manual editing of the second safety control device 200′. If such an incompatible change occurs, the converter 300 thus preferably prepares a first delta list 301, which indicates deviations of the first safety configuration file 100′ from the second safety configuration file 200′. In the present example, this would relate to the configuration data 102b′.

When checking the consistency of the first safety configuration file 100′ and the second safety configuration file 200′ by means of the consistency checking unit 400, the consistency of the parts of the safety configuration files 100′, 200′, which are not affected by an incompatible change, can be checked. The consistency checking unit 400 preferably outputs a second delta list 401, which is preferably compared to the first delta list 301. If the delta lists 301, 401 correspond, the corresponding parts 102a′, 202a′ of the safety configuration files 100′, 200′ are thus consistent.

The configuration data 202c′ of the second safety control device 200′ are preferably assigned to a third safety function, which is first to be available in the changed safety control device. For example, these configuration data can relate to the rotational angle monitoring of the axis 3. These configuration data 202c′ cannot be generated by the converter 300, since they do not have an equivalent in the first safety configuration file 100′. Therefore, these configuration data 202c′ have to be edited later into the safety configuration file 200′. The configuration data 202c′ are therefore unimportant for the conversion of the first safety configuration file 100′ into the second safety configuration file 200′.

FIG. 3 schematically shows a preferred method for activating a second safety configuration file 200″. The safety configuration file 200″ comprises an identifier 201″ and configuration data 202″.For the activation, the safety configuration file 200″ is provided in a data processing system 700 of a manipulator system 10. The manipulator system 10 comprises a manipulator 500, a control device 600, and a safety control device 800. The identifier 101″ of the presently valid safety configuration file, i.e., the activated safety configuration file, is saved or stored in the safety control device 800. Before the manipulator system can be put into operation, it is checked whether the stored identifier 101″ corresponds to the identifier 201″ of the safety configuration file 200″ provided in the data processing system ₇00. If the identifiers 101″, 201″ correspond, the manipulator system 10 can thus be started and the manipulator 500 can be moved by means of the control device 600. Otherwise, an activation of the safety configuration file 200″ stored in the system is not possible without prior verification by an operator. The system can therefore first be put into operation after successful activation of the safety configuration file 200″ stored in the system.

The identifier 201″ of the safety configuration file 200″ to be activated is particularly preferably also saved in a memory of the manipulator 500 and/or in a memory of the control device 600. Before the manipulator system 10 can be started, it is then checked whether the identifier 101″ saved in the safety control device 800 corresponds to the identifiers which are saved in a memory of the manipulator 500 and/or in a memory of the control device 600. The activation of an unsuitable safety configuration file can thus be reliably avoided.

It should be noted that the invention claimed herein is not limited to the described embodiments, but may be otherwise variously embodied within the scope of the claims listed infra.

### LIST OF REFERENCE NUMERALS

1, 1′: method for conversion

10: manipulator system

100; 100′; 100″: first safety configuration file

101, 101′, 101″: identifier of the first safety configuration file

102: configuration data

102a′, 102b′: configuration data

200; 200′; 200″: second safety configuration file

201; 201′; 201″: identifier of the second safety configuration file

202, 202″: configuration data

202a′, 202c′ configuration data

300: converter

301: delta list, prepared by the converter

400: consistency checking unit

401 delta list, prepared by the consistency checking unit

500: manipulator

600: control device

700: data processing system

800: safety control device

1. A method for converting at least one first safety configuration file of a safety control device into a second safety configuration file, wherein the safety control device is a manipulator safety control device, and wherein the method comprises the following steps:
a) converting the first safety configuration file into the second safety configuration file by means of a converter; and
b) checking the consistency of the first safety configuration file and the second safety configuration file by means of a consistency checking unit.

2. The method for converting according to claim 1, wherein the first safety configuration file has at least one first identifier and first configuration data and the conversion of the first safety configuration file comprises at least the conversion of the configuration data, and the configuration data comprise at least one of safety parameters or safety function selection parameters.

3. The method for converting according to claim 1, wherein the identifier of the first safety configuration file is not converted, so that the second safety configuration file has the same identifier as the first safety configuration file.

4. The method for converting according to claim 1, wherein the identifier of the first safety configuration file is an independent identifier.

5. The method for converting according to claim 1, wherein during the checking of the consistency of the first and second safety configuration files, it is checked whether the safety function selection parameters which are implemented in the first safety configuration file are also implemented in the second safety configuration file.

6. The method for converting according to claim 1, wherein during the checking of the consistency of the first and second safety configuration files, it is checked whether the safety parameters which are implemented in the first safety configuration file correspond to the safety parameters which are implemented in the second safety configuration file.

7. The method for converting according to claim 1, wherein the identifier of the second safety configuration file is changed if an inconsistency is determined upon checking the consistency.

8. The method for converting according to claim 1, wherein the method furthermore comprises the following step:
c) preparing a first delta list by means of the converter if a complete conversion of the first safety configuration file into the second safety configuration file is not possible, wherein the first delta list indicates deviations of the first safety configuration file from the second safety configuration file.

9. The method for converting according to claim 8, wherein the first delta list is output to an operator.

10. The method for converting according to claim 8, wherein the method comprises at least the further steps of:
d) preparing a second delta list by means of the consistency checking unit, wherein the second delta list indicates deviations of the first safety configuration file from the second safety configuration file, and
e) outputting the first and second delta lists.

11. The method for converting according to claim 1, wherein the method comprises at least the further step of
f) activating the second safety configuration file if the identifier of the second safety configuration file corresponds to an identifier, which is stored in a safety control device.

12. The method for converting according to claim 1, wherein one or more of the converting or the checking steps is performed “off-line.”

13. The method for converting according to claim 10, wherein the method furthermore comprises the following steps:
g) editing the first safety configuration file into the second safety configuration file by means of an editor;
h) preparing a third delta list by means of the editor, wherein the third delta list indicates deviations of the first safety configuration file from the second safety configuration file;
i) checking the consistency of the first safety configuration file and the second safety configuration file by means of a consistency checking unit;
j) outputting the second and third delta lists.

14. A data processing system for converting at least one first safety configuration file of a safety control device into a second safety configuration file, wherein the safety control device is a manipulator safety control device, the system configured to:
a) convert the first safety configuration file into a second safety configuration file by means of a converter; and
b) check the consistency of the first safety configuration file and the second safety configuration file by means of a consistency checking unit.

15. A tangible, non-transitory machine-readable storage medium containing instructions which when executed by cause a data processing system to execute a method for converting at least one first safety configuration file of a safety control device into a second safety configuration file, wherein the safety control device is a manipulator safety control device, and wherein the method comprises the following steps:
a) converting the first safety configuration file into a second safety configuration file by means of a converter; and
b) checking the consistency of the first safety configuration file and the second safety configuration file by means of a consistency checking unit.

16. The method for converting according to claim 1, wherein an error message is output if an inconsistency is determined upon checking the consistency.
